(19) United States
(12) Patent Application Publication
(10) Pub. No.: US 2007/0216770 A1
(43) Pub. Date: Sep. 20, 2007

(54) License plate light having attached video camera

(75) Inventor: Cheng-Chung Chang, Hsi-Chih City (TW)

Correspondence Address: TROXELL LAW OFFICE PLLC, SUITE 1404, 5205 LEESBURG PIKE, FALLS CHURCH, VA, 22041, US

(73) Assignee: COLITEC Co., Ltd.

(21) Appl. No.: 11/378,373

(22) Filed: Mar. 20, 2006

(51) Int. Cl. H04N 7/18

(52) U.S. Cl. 348/148

(57) ABSTRACT

A license plate light comprises: a box; at least one light-emitting device mounted inside said box; a video camera mounted inside said box; and a transparent cover coupled with said box, whereby said at least one light-emitting device and said video camera integrate with each other and share a wiring path to facilitate vehicle's wiring.

### FIELD OF THE INVENTION

The present invention relates to a license plate light having an attached video camera and this license plate light is suitable for various vehicles or the likes.

### BACKGROUND OF THE INVENTION

The motor vehicle is a kind of very convenient transportation tool. By using the rearview mirrors, which are mounted on both sides and the center of the vehicle, the driver can observe the surrounding images from the vehicle's seat. However, these rearview mirrors cannot reflect the images right behind the vehicle. In response to this, the vehicle is provided with the backing radar and the video camera. Besides, many vehicles are also provided with light sources above the license plates so as to show the license plate number clearly.

However, the conventional license plate light and video camera are mounted independently. Two wiring paths must be provided in order to assemble both of them. As a result, it takes a long time for attaching the light sources and the video camera to the vehicle. It means that this vehicle is not available for a long time and the assembly cost is thus very high. Moreover, the conventional backing radar is generally mounted on the center of the bumper or on the top of the vehicle. As a result, the driver can observe the captured images from the video camera via the monitor while backing the vehicle so as to avoid collision or danger by observing the rear images.

However, the mounting position of the conventional video camera is so excessively high or low that the capture angle of the video camera is confined. When the video camera is mounted on a lower bumper, the capture images cannot be recognized clearly in a darker surrounding. Moreover, when the video camera is mounted on a lower bumper, it is easily damaged by careless backing or impacted by other vehicle in the rear.

In view of the foregoing defects, the present inventor makes diligent studies in providing consumers with a license plate light having an attached video camera according to the motive of the present invention.

### SUMMARY OF THE INVENTION

It is a main object of the present invention to integrate a video camera with a license plate light such that they can share a wiring path.

It is another object of the present invention to combine a video camera with a license plate light for providing the license plate number and the video camera with proper illumination, thereby obtaining the clear images.

In order to achieve the above-mentioned objects, the present invention discloses a license plate light comprising: a box; at least one light-emitting device mounted inside said box; a video camera mounted inside said box; and a transparent cover coupled with said box, whereby said at least one light-emitting device and said video camera integrate with each other and share a wiring path to facilitate vehicle's wiring.

The aforementioned objects and advantages of the present invention will be readily clarified in the description of the preferred embodiments and the enclosed drawings of the present invention.

### BRIEF DESCRIPTION OF THE DRAWINGS

FIG. 1 is a three-dimensional view showing a preferred embodiment of the present invention.

FIG. 2 is an exploded view showing the components of the preferred embodiment of the present invention.

FIG. 3 is a schematic, enlarged view showing a light-emitting device of the present invention.

FIG. 4 is a schematic view showing that the license plate light is coupled with a vehicle in accordance with the preferred embodiment of the present invention.

### DETAILED DESCRIPTION OF THE PREFERRED EMBODIMENT

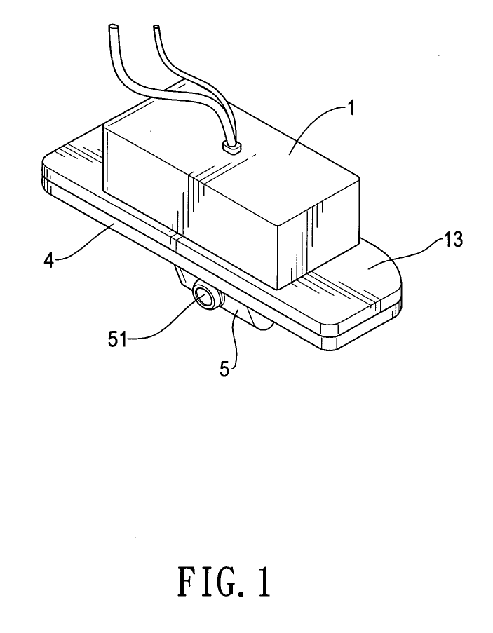

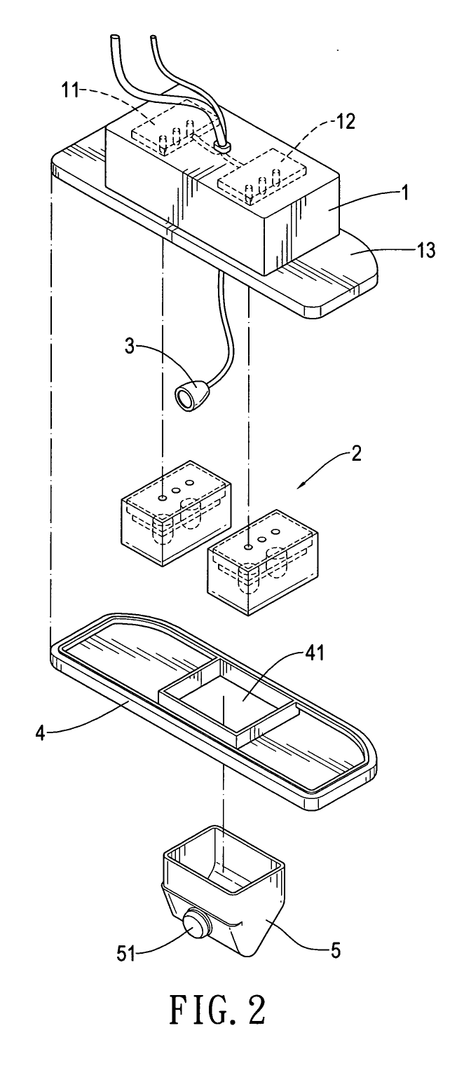

Referring to FIG. 1 and FIG. 2, a license plate light having an attached video camera of the present invention comprises a box 1, at least one light-emitting device 2, a video camera 3, a transparent cover 4, and a camera-protecting cover 5, wherein an amount of plug is mounted on the inside of the box 1 in response to that of the light-emitting device 2. In this preferred embodiment, two plugs 11, 12 are mounted on both inner sides of the box 1, respectively. Besides, a protrudent flange 13 is formed outwardly, horizontally on an opening of the box 1.

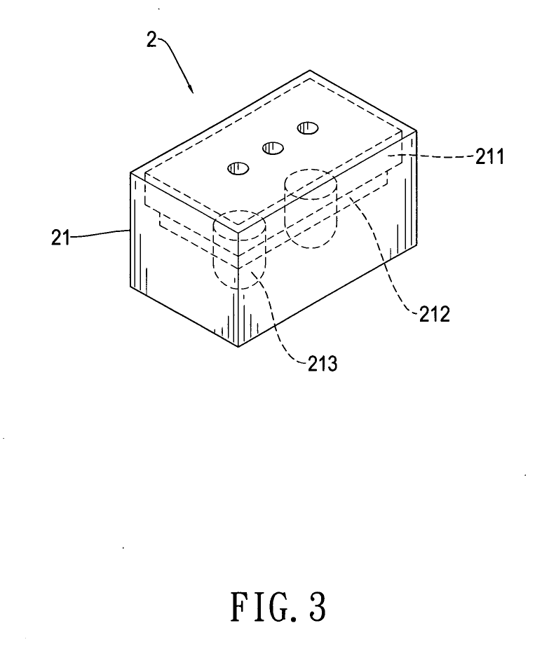

The above-mentioned light-emitting device 2 is, for example, a light bulb, a light-emitting diode, etc. In this preferred embodiment, two light-emitting diodes are exemplified. Referring to FIG. 3 simultaneously, each light-emitting device 2 comprises two light-emitting diodes 213, which are attached to a circuit board 212, wherein a socket 211 is attached to the backside of the circuit board 212. In addition, a light-condensing frame 21 is utilized to cover the light-emitting diodes 213, the circuit board 212, and the socket 211.

The video camera 3 is connected to the box 1.

The transparent cover 4 is located to conform to the protrudent flange 13, which is located on the opening of the box 1. In addition, a hole 41 is formed on the center of the transparent cover 4.

The camera-protecting cover 5 is coupled to the hole 41 of the transparent cover 4, wherein the bottom the camera-protecting cover 5 is formed to be two inward-slanted lateral surfaces. In addition, a protrudent part 51 is formed on one of the lateral surfaces. Alternatively, the transparent cover 4 may be integrally coupled with the camera-protecting cover 5.

In the assembly process, the plugs 11, 12 of the box 1 are firstly inserted into the sockets 211 of these two light-emitting devices 2 such that the video camera 3, which is connected to the box 1, can be located between these two light-emitting devices 2. Then, the camera-protecting cover 5 is embedded in the hole 41 of the transparent cover 4. Thereafter, the video camera 3 is located on the protrudent part 51 of the camera-protecting cover 5. Finally, the transparent cover 4 is coupled with the protrudent flange 13, which is located on the opening of the box 1.

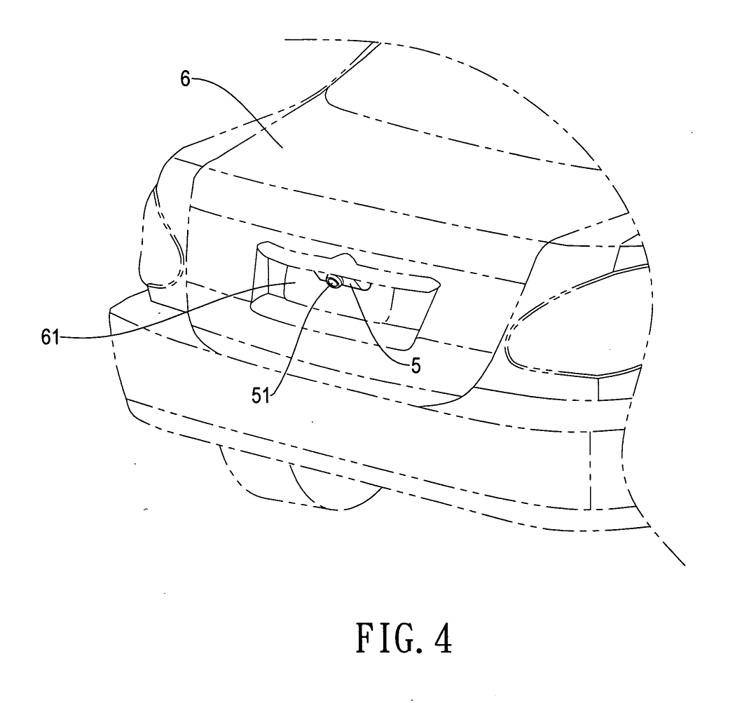

When in use, as shown in FIG. 1 through FIG. 4, the box 1 is attached above a license plate 61, which is located on the backside of a vehicle 6, wherein the protrudent part 51 of the camera-protecting cover 5 is located to face outward so as to capture images behind the vehicle 6. In addition, the camera-protecting cover 5 is designed to protect the video camera 3 against dust and rain and to prevent damage. Besides, the light emitting devices 2, which are mounted on both sides of the video camera 3, respectively, can downward emit light beams via the transparent cover 4 to show the license plate number clearly.

In accordance with the foregoing description, it is apparent that the license plate light of the present invention provides the following advantages, wherein:

1. the light-emitting devices and the video camera can be integrated effectively with each other such that these two components can be assembled simultaneously by one assembly step;

2. the required time for assembling the light-emitting devices and the video camera to the vehicle can be shortened effectively and the assembly cost can be reduced as well; and

3. the light beams emitted from the light-emitting devices not only clearly illuminates the license plate number but also provides the video camera with proper illumination for capturing images clearly.

In summary, the license plate light having the attached video camera of the present invention can integrate the light-emitting devices with the video camera effectively. Accordingly, the present invention satisfies patentability and is therefore submitted for a patent.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. A license plate light comprising:
a box;
at least one light-emitting device mounted inside said box;
a video camera mounted inside said box; and
a transparent cover coupled with said box, whereby said at least one light-emitting device and said video camera integrate with each other and share a wiring path to facilitate vehicle's wiring.

2. The license plate light of claim 1, wherein a plug for insertion into said at least one light-emitting device is mounted on both inner sides of said box.

3. The license plate light of claim 2, wherein said at least one light-emitting device is composed of two light-emitting devices, each comprising a plurality of light-emitting diodes coupled with a circuit board, wherein a socket is mounted on the backside of said circuit board corresponding to said plug mounted inside said box and a light-condensing frame is utilized to cover said plurality of light-emitting diodes, said circuit board, and said socket.

4. The license plate light of claim 1, wherein a protrudent part is integrally formed on said transparent cover for mounting said video camera.

5. The license plate light of claim 1, wherein a hole is formed on said transparent cover for coupling with a camera-protecting cover.

6. The license plate light of claim 5, wherein the bottom of said camera-protecting cover is formed to be two inward-slanted lateral surfaces and a protrudent part is integrally formed on one of said inward-slant lateral surfaces for mounting said video camera.
